(19) United States
(12) Patent Application Publication
(10) Pub. No.: US 2012/0124662 A1
(43) Pub. Date: May 17, 2012

(54) METHOD OF USING DEVICE MOTION IN A PASSWORD

(76) Inventors: Jim S. Baca, Corrales, NM (US); Ronald Tafoya, Sandia Park, NM (US); Thomas R. Bowen, Albuquerque, NM (US)

(21) Appl. No.: 12/947,042

(22) Filed: Nov. 16, 2010

(51) Int. Cl. G06F 21/00

(52) U.S. Cl. 726/17

(57) ABSTRACT

Processing a password in a mobile computing device may be accomplished by sensing movement of the mobile computing device by an accelerometer of the mobile computing device in three dimensional space; capturing first directional motion information representing the movement as at least a portion of an entered password; comparing the entered password to a password previously stored in the mobile computing device, the stored password comprising second captured directional motion information; and allowing access to the mobile computing device by a user when the entered password matches the stored password. The movement of the mobile computing device required for the password may be set by the user during a password training phase of operating the mobile computing device.

### FIELD

The present disclosure generally relates to the field of security of mobile computing devices. More particularly, an embodiment of the invention relates to using directional motion information of a mobile computing device as part of user authentication.

### BACKGROUND

Computing devices may become “locked” to deter unauthorized use according to known methods. Passwords are commonly used as a simple mechanism for enabling user authentication. When a computing device is locked, the user enters the password, typically via a keyboard. If the correct password is entered, the computing device is unlocked and available for continued use. Some passwords for some computing devices, such as mobile computing devices (e.g., cell phones), are simple personal identification numbers (PINs). In some devices, the length of the PIN is only four digits, which provides only minimal security. If the computing device is lost or stolen, it may be possible for an attacker to guess the PIN and thus access the device. Hence, better methods of securing mobile computing devices are needed.

Some computing devices include an accelerometer. Typically, the accelerometer is used to detect orientation of the device resulting in a change of the display orientation (portrait or landscape mode), or to detect a shock condition from a fall. In some devices, sensing by the accelerometer of the user shaking the device may result in an action such as answering an incoming phone call. However, such sensed conditions are crude, often indicating merely conditions such as the tilt/orientation of the device or the presence of shock to the device.

Some computing devices include a touch screen. In some of these devices, a touch gesture on the touch screen may unlock or reactivate the device from a sleep state. One problem with this approach is that the gesture will be entered many times and detection of the gesture can be made by someone who has stolen the device by analyzing the touch screen surface. Again, better methods of securing mobile computing devices are need.

### BRIEF DESCRIPTION OF THE DRAWINGS

The detailed description is provided with reference to the accompanying figures. The use of the same reference numbers in different figures indicates similar or identical items.

FIG. 1 is an example of a sequence of motions for use in a password for a mobile computing device according to an embodiment of the present invention.

FIG. 2 is an example of combining a sequence of motions and additional user inputs for use in a password for a mobile computing device according to an embodiment of the present invention.

FIG. 3 is a simplified diagram of a mobile computing device according to an embodiment of the present invention.

FIG. 4 is a flow diagram of a password training mode for a mobile computing device according to an embodiment of the present invention.

FIG. 5 is a flow diagram of password processing according to an embodiment of the present invention.

FIG. 6 illustrate a block diagram of an embodiment of a mobile computing device.

### DETAILED DESCRIPTION

Embodiments of the present invention comprise methods for using directional motion information of a mobile computing device as at least a portion of a password entered by a user in order to be authenticated to use the mobile computing device. In embodiments of the present invention, a mobile computing device may include a cellular telephone, a smart phone, a tablet computing device, a personal digital device, a personal digital assistant, a netbook, a handheld computer, or any other computing device that may be moved. In various embodiments, the mobile computing device may be any small form factor computing device.

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs stored on a computer readable storage medium (“software”), or some combination of hardware and software. For the purposes of this disclosure reference to “logic” shall mean hardware, software (including for example micro-code that controls the operations of a processor), firmware, or some combination thereof.

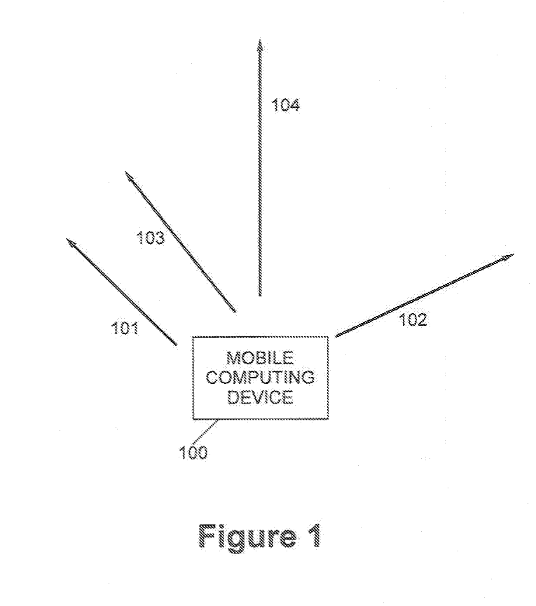

FIG. 1 is an example of a sequence of motions for use in a password for a mobile computing device according to an embodiment of the present invention. In an embodiment, a password may include a specific set of motions performed by the user with the mobile computing device. Typically this would involve the user holding the mobile computing device with one or both hands and moving the whole device in a physical gesture in a premeditated and purposeful way. The movement of the mobile computing device in three dimensions may be sensed by an accelerometer within the mobile computing device. The sensed motion may be translated into digital directional motion information. In an embodiment, this directional motion information may comprise at least part of the password. For example, as shown in FIG. 1, the user holds mobile computing device 100 and, at the appropriate time, moves the device along vector 101. Vector 101 may be any vector in three dimensional space. In one embodiment, after returning the device to an approximate starting position in three dimensional space, the user then moves the device along vector 102. After returning the device to an approximate starting position in three dimensional space, the user then moves the device along vector 103. Finally, after returning the device to an approximate starting position in three dimensional space, the user then moves the device along vector 102. In this simple example, these four movements become part of the password for the mobile computing device, and unlocking the device requires the user to perform these four movements in sequence at the appropriate time while holding the device.

It is to be understood that this example is merely illustrative and not limiting. The number of movements, whether or not the device is returned to an approximate starting position between movements, the velocity and acceleration of each of the movements, whether the movement is on a two dimensional plane, and whether the movements are discrete or comprise a continuous movement for a period of time (e.g., moving the device in a circle, and so on), are all implementation-dependent considerations. In embodiments of the present invention, any movement of the device in any of the three dimensions that can be sensed by an accelerometer may comprise at least a portion of the password.

In an embodiment, the fourth dimension of time may also be a component of the password. Time may be obtained from a clock within the mobile computing device. In an embodiment, there may be an overall time limit to perform the password motions once commenced. For example, the motions may be required to be concluded within three seconds. Further, in an embodiment, time delays between discrete motions may also be included in the password. For example, the user may delay one second between motions. In embodiments of the present invention, any combination of movements of the device in three dimensions along with time spent moving or not moving the device during those movements may comprise at least a portion of the password.

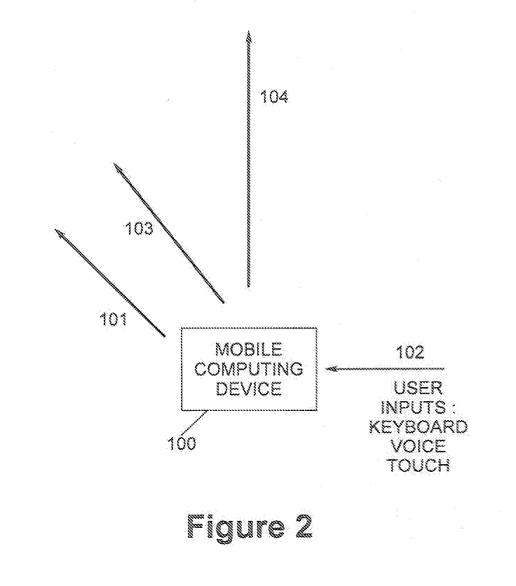

FIG. 2 is an example of combining a sequence of motions and additional user inputs for use in a password for a mobile computing device according to an embodiment of the present invention. In this example, the user first moves the device along vector 101. Next, the user makes one or more additional user inputs 102 using conventional user input devices of the mobile computing device. In various embodiments, any user input devices which are part of the mobile computing device may be employed. For example, the user may make one or more keyboard entries using a physical keyboard (hard keys) or virtual keyboard (soft keys) of the device. The user then moves the device along vector 103, and subsequently vector 104. The keyboard entries may be done before, during, or after the device movements. In an embodiment, the combination of the device movements and the one or more keyboard entries comprise the password.

In other embodiments, other user inputs along with directional motion information may comprise at least a portion of the password. In an embodiment, an audio or voice component may comprise a portion of the password. The user may speak an utterance into a microphone of the mobile computing device, which may then be captured and stored as part of the password. In an embodiment, this may be accomplished using known voice recognition techniques. The utterance may be done before, during, or after the device movements. For example, a password may include having the user, when prompted, speak a predetermined word or phrase into the microphone, then move the device in a certain way (or vice versa). In another example, the user may have to move the device a certain way, speak a predetermined word or phrase, and then move the device the same or another way.

In another embodiment, one or more touches on a touch screen of the mobile computing device may comprise a portion of the password along with the directional motion information. For example, the password may include having the user touch the screen a predetermined number of times in one or more predetermined locations before, during, or after movement of the whole device.

In various embodiments, any one or more of keyboard entries, voice utterances, and/or touch screen entries may be included as user inputs into the password along with the motion information. Additionally, in other embodiments, a scanned fingerprint and/or iris may also be included in the password according to known methods of obtaining fingerprint and iris scans.

In an embodiment, the device movement forming at least a portion of the password may comprise tilting the device at least one time in a direction. In another embodiment, the device movement forming at least a portion of the password may comprise a sequence of tilting the device multiple times, with each tilt movement being in any direction.

As can be seen, the combination of conventional user inputs and device movements forming the password according to embodiments of the present invention are limitless. By requiring device movement as at least part of the password, security may be improved.

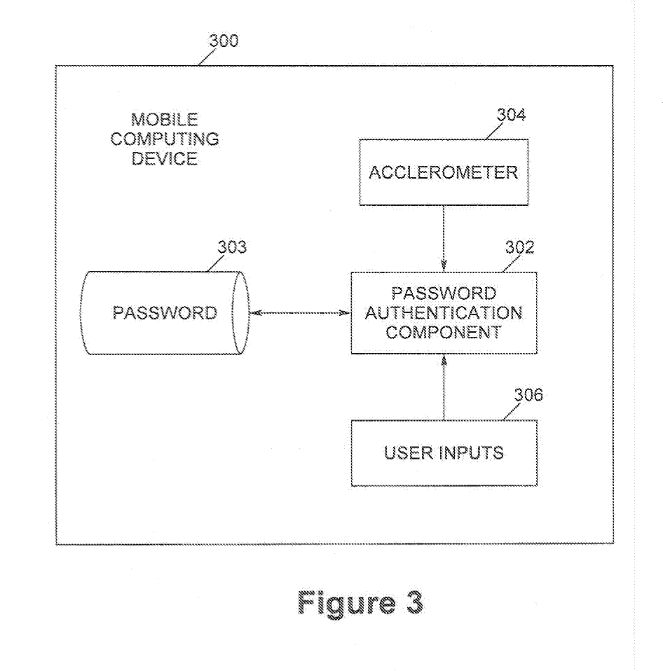

FIG. 3 is a simplified diagram of a mobile computing device 300 according to an embodiment of the present invention. Mobile computing device 300 comprises a password authentication component 302. The password authentication component operates to capture and store a password based at least in part on directional motion information of the device generated during a password training phase. The password 303 may be stored in a memory of the device. In an embodiment, the password may be stored in a secure storage which deters tampering. In an embodiment, the password may be stored as a cryptographic hash of the directional motion information, subject to implementation dependent tolerances. In another embodiment, the password may be stored as a cryptographic hash of the directional motion information and the additional user inputs.

An accelerometer is a device that senses proper acceleration, the acceleration experienced relative to freefall. A multi-axis accelerometer detects magnitude and direction of the acceleration as a vector quantity, and may be used to sense orientation, acceleration, vibration shock, and falling. In an embodiment, accelerometer 304 comprises a three axis accelerometer. In an embodiment, accelerometer 304 may be included to sense motion of the device and generate directional motion information, and forward the directional motion information to the password authentication component. Thus, the accelerometer not only detects motion and/or orientation of the device, but direction of movement as well. In an embodiment, the accelerometer generates directional motion information representing the movement of the device in three dimensional space. The password authentication component may combine this directional motion information with timing information from a clock of the mobile computing device.

In an embodiment, the accelerometer may be a single axis accelerometer, and the mobile computing device may further comprise a gyroscope to provide device orientation. In this embodiment, the combination of the movement sensed by the accelerometer and the gyroscope may comprise the directional motion information.

In an embodiment, user inputs 306 may be obtained from user input devices such as a keyboard, microphone, or touch screen. The password authentication component subsequently operates to store current directional motion information and optionally current additional user inputs and compare the current directional motion information and current additional user inputs to the stored password 303. If they match, access may be enabled to the mobile computing device. If they do not match, access may remain disabled.

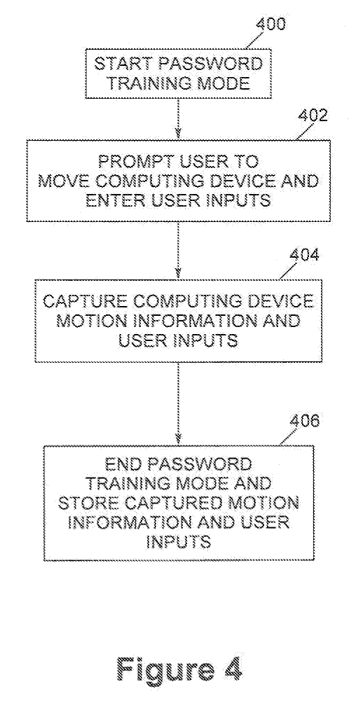

FIG. 4 is a flow diagram of a password training mode for a mobile computing device according to an embodiment of the present invention. At block 400, a password training mode may be started as a result of a user input during setup operations for the mobile computing device. At block 402, the mobile computing device may prompt the user (via a user interface) to move the device in a user-defined way. The user interface of the device may instruct the user to remember the movements so that the user can correctly recreate the movements for re-entering the password at a later point in time. In an embodiment, threshold conditions on the directional motion information may be set so that later motions made during a password entry phase approximating the motions made during the password training phase may be determined to match each other. That is, if the motions are within a pre-determined threshold of each other, they will be determined to be a match.

In an embodiment, the user may also be prompted to enter one or more additional user inputs from a keyboard, microphone, touch screen, or other user input device. In an embodiment, these user inputs may be combined with purposeful motion of the device by the user to form the password. At block 404, the mobile computing device captures the directional motion information generated as a result of sensing the user's movement of the device and optionally the additional user inputs in the sequence performed by the user. At block 406, the password training mode is ended and the sequence of captured directional motion information and user inputs may be stored for further use as the user's stored password for the device. In an embodiment, a cryptographic hash operation may be applied to the captured data, and the results of the hash operation stored as the password.

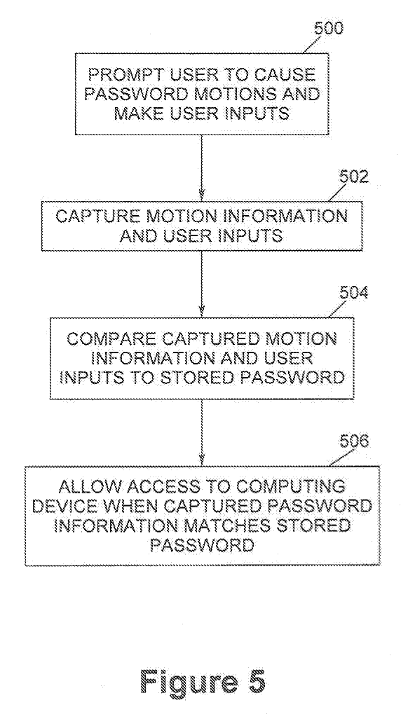

FIG. 5 is a flow diagram of password processing according to an embodiment of the present invention. At any time after the password training phase has concluded, the user may desire to enter the user's password into the mobile computing device for any purpose. For example, the password may need to be entered to unlock access to the device or to change device settings. At that time, the user may be prompted at block 500 via a user interface to move the device in such a way as to enter a password to correspond to the stored password. In an embodiment, the prompting may start a period of time for entry of the password by the user. In an embodiment, the starting and ending of password entry operations may be started by the user via a predetermined user input. In an embodiment, the starting of the password entry operations may be started by the user via a predetermined user input, and ended automatically after a predetermined period of time.

In an embodiment, if the user included one or more additional user inputs in the password during the password training phase, the user may be prompted to also enter the one or more additional user inputs (e.g., keyboard entries, voice utterances, and/or touch screen entries). In another embodiment, it may be presumed that the user already knows how and when to make the motions and enter any additional user inputs without being prompted by the device. At block 502, the directional motion information may be captured. In an embodiment, additional user inputs, if any, may also be captured. Timing between motions and/or user inputs may also be part of the password. Clock information may be obtained within the mobile computing device for this purpose. At block 504, the captured motion information and optionally the additional user inputs representing the entered password may be compared to the stored password. If the sequence of captured motion information and the additional user inputs, if any, match the stored password, then access to the mobile computing device features and functions may be allowed.

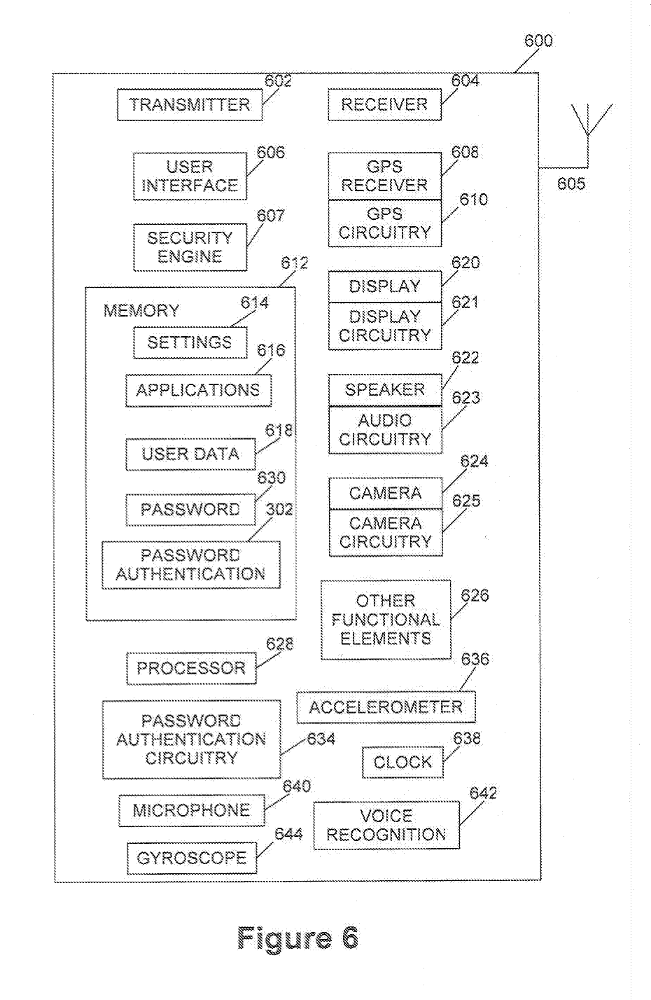

FIG. 6 illustrates an embodiment of a mobile computing device. In this illustration, a mobile computing device 600 includes elements for capturing and authenticating a password of the mobile computing device. In some embodiments, a mobile computing device 600 includes one or more transmitters 602 and receivers 604 for transmitting and receiving data. In some embodiments, the mobile computing device includes one or more antennas 605 for the transmission and reception of data, where the antennas may include dipole and monopole antennas. The mobile computing device 600 may further include a user interface 606, including, but not limited to, a graphical user interface (GUI). The mobile computing device 600 may further include one or more elements for the determination of physical location or velocity of motion, including, but limited to, a GPS receiver 608 and GPS circuitry 610.

The mobile computing device 600 may further include one or more memories and/or sets of registers 612, which may include non-volatile memory, such as flash memory, and other types of memory. The memory or registers 612 may include one or more groups of settings 614 for the device, including default settings, user-set settings established by user of the mobile computing device, and enterprise-set settings established by an enterprise, such as an employer, who is responsible for IT (information technology) support. The memory 612 may further include one or more applications 616, including applications that support or control operations of the mobile computing device. The memory 612 may further include user data 618. The memory 612 may further include a password 630 that comprises directional motion information, and optionally additional user inputs. In an embodiment, the memory 612 further includes password authentication component 302 embodied as instructions for execution by processor 628 to compare a stored password 630 to captured directional motion information and optionally additional user inputs.

The mobile computing device may include various additional elements. The mobile device may include a display 620 and display circuitry 621; a speaker 622 and audio circuitry 623 including audible signaling (ringers); a camera 624 and camera circuitry 625 and other functional elements 626. In an embodiment, display 620 may be a touch screen display. A security engine 607 may be provided in some embodiments to provide cryptographic and other security processing for the mobile computing device. In an embodiment, the security engine may provide for protection of the password stored in memory against attempts for unauthorized access to the password.

In an embodiment, the mobile computing device comprises an accelerometer 636 to sense directional motion of the device. The mobile computing device also comprises a clock 638 to obtain current time information. In an embodiment, password authentication component 302 may be implemented as password authentication hardware circuitry 634. In an embodiment, mobile computing device includes a microphone 640 for capturing voice utterances of the user, as well as voice recognition component 642 to process those voice utterances according to know methods. In an embodiment, a gyroscope 644 may also be included in the mobile computing device to provide orientation information.

In various embodiments of the invention, the operations discussed herein, e.g., with reference to FIGS. 3-5, may be implemented as hardware (e.g., logic circuitry), software (including, for example, micro-code that controls the operations of a processor such as the processor discussed with reference to FIG. 6), firmware, or combinations thereof, which may be provided as a computer program product, e.g., including a tangible machine-readable or computer-readable medium having stored thereon instructions (or software procedures) used to program a computing device (e.g., a processor or other logic of a computing device) to perform an operation discussed herein. The machine-readable medium may include a storage device such as those discussed herein.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Additionally, such computer-readable media may be downloaded as a computer program product, wherein the program may be transferred from a remote computer (e.g., a server) to a requesting computer (e.g., a client) by way of data signals, via a communication link (e.g., a bus, a modem, or a network connection).

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. A method of processing a password in a mobile computing device comprising:
sensing at least one movement of the mobile computing device by an accelerometer of the mobile computing device in three dimensional space;
capturing first directional motion information representing the at least one movement as at least a portion of an entered password;
comparing the entered password to a password previously stored in the mobile computing device, the stored password comprising second captured directional motion information; and
allowing access to the mobile computing device by a user when the entered password matches the stored password.

2. The method of claim 1, further comprising capturing the second captured directional motion information sensed as a result of the user moving the computing mobile device during a password training phase of operation of the mobile computing device and storing the second captured directional motion information as at least a portion of the stored password in a memory of the mobile computing device.

3. The method of claim 2, wherein the at least one movement comprises a sequence of movements by the user of the mobile computing device in three dimensional space.

4. The method of claim 3, wherein the stored password and the entered password further comprise timing information relating to the sequence of movements.

5. The method of claim 3, wherein the stored password comprises at least one keyboard entry by the user in combination with the second captured directional motion information, and further comprising accepting at least one keyboard entry as at least a portion of the entered password.

6. The method of claim 3, wherein the stored password comprises at least one voice utterance of the user in combination with the second captured directional motion information, and further comprising accepting at least one voice utterance as at least a portion of the entered password.

7. The method of claim 3, wherein the stored password comprises at least one touch screen input by the user in combination with the second captured directional motion information, and further comprising accepting at least one touch screen input as at least a portion of the entered password.

8. A computer-readable medium comprising one or more instructions that when executed on a processor of a mobile computing device perform one or more operations to process a password by
capturing first directional motion information representing at least one movement of the mobile computing device in response to sensing the at least one movement by an accelerometer of the mobile computing device in three dimensional space, the first captured directional motion information comprising at least a portion of an entered password;
comparing the entered password to a password previously stored in the mobile computing device, the stored password comprising second captured directional motion information; and
allowing access to the mobile computing device by a user when the entered password matches the stored password.

9. The computer-readable medium of claim 8, further comprising instructions to capture the second captured directional motion information sensed as a result of the user moving the computing mobile device during a password training phase of operation of the mobile computing device and to store the second captured directional motion information as at least a portion of the stored password in a memory of the mobile computing device.

10. The computer-readable medium of claim 9, wherein the at least one movement comprises a sequence of movements by the user of the mobile computing device in three dimensional space.

11. The computer-readable medium of claim 10, wherein the stored password and the entered password further comprise timing information relating to the sequence of movements.

12. The computer-readable medium of claim 10, wherein the stored password comprises at least one keyboard entry by the user in combination with the second captured directional motion information, and further comprising instructions to accept at least one keyboard entry as at least a portion of the entered password.

13. The computer-readable medium of claim 10, wherein the stored password comprises at least one voice utterance of the user in combination with the second captured directional motion information, and further comprising instructions to accept at least one voice utterance as at least a portion of the entered password.

14. The computer-readable medium of claim 10, wherein the stored password comprises at least one touch screen input by the user in combination with the second captured directional motion information, and further comprising instructions to accept at least one touch screen input as at least a portion of the entered password.

15. A mobile computing device comprising:
an accelerometer to sense at least one movement of the mobile computing device in three dimensional space; and
a password authentication component to
capture first directional motion information representing the at least one movement as at least a portion of an entered password;
compare the entered password to a password previously stored in the mobile computing device, the stored password comprising second captured directional motion information; and
allow access to the mobile computing device by a user when the entered password matches the stored password.

16. The mobile computing device of claim 15, wherein the mobile computing device further comprises a memory, and wherein the password authentication component is to capture the second captured directional motion information sensed as a result of the user moving the computing mobile device during a password training phase of operation of the mobile computing device and to store the second captured directional motion information as at least a portion of the stored password in the memory.

17. The mobile computing device of claim 16, wherein the at least one movement comprises a sequence of movements by the user of the mobile computing device in three dimensional space.

18. The mobile computing device of claim 17, wherein the mobile computing device further comprises a clock, and wherein the stored password and the entered password further comprise timing information relating to the sequence of movements.

19. The mobile computing device of claim 17, wherein the mobile computing device further comprises a keyboard, wherein the stored password comprises at least one keyboard entry by the user in combination with the second captured directional motion information, and wherein the password authentication component is to accept at least one keyboard entry as at least a portion of the entered password.

20. The mobile computing device of claim 17, wherein the mobile computing device further comprises a microphone and a voice recognition component, wherein the stored password comprises at least one voice utterance of the user in combination with the second captured directional motion information, and wherein the password authentication component is to accept at least one voice utterance as at least a portion of the entered password.

21. The mobile computing device of claim 17, wherein mobile computing device further comprises a touch screen display, wherein the stored password comprises at least one touch screen input by the user in combination with the second captured directional motion information, and wherein the password authentication component is to accept at least one touch screen input as at least a portion of the entered password.
